(19) United States
(12) Patent Application Publication
(10) Pub. No.: US 2019/0155588 A1
(43) Pub. Date: May 23, 2019

(54) SYSTEMS AND METHODS FOR TRANSFORMING MACHINE LANGUAGE MODELS FOR A PRODUCTION ENVIRONMENT

(71) Applicant: JPMorgan Chase Bank, N.A., New York, NY (US)

(72) Inventors: Sangameswara PANCHOMARTHI, Bear, DE (US); Sangram Kesari DAS, Monmouth Junction, NJ (US); Syed Rizwan ALI, Aston, PA (US); Souma Suvra Ghosh, Wilmington, DE (US)

(21) Appl. No.: 15/820,942

(22) Filed: Nov. 22, 2017

(51) Int. Cl. G06F 8/51; G06N 99/00

(52) U.S. Cl. CPC G06F 8/51; G06N 99/005

(57) ABSTRACT

Systems and methods for transforming machine language models for a production environment are disclosed. In one embodiment, in an information processing device comprising at least one computer processor, a method for transforming machine language models for a production environment may include: (1) receiving, from a software development environment, a machine language model in a first language; (2) transforming the machine language model from the first language to a second language; (3) validating the transformed model in an operational environment; and (4) deploying the transformed model to a production environment.

### BACKGROUND OF THE INVENTION

### 1. Field of the Invention

The present disclosure generally relates to systems and methods for transforming machine language models for a production environment.

### 2. Description of the Related Art

Machine learning models are commonly used in open source environments. These environments, however, often do not provide availability, speed, or scalability needed.

### SUMMARY OF THE INVENTION

Systems and methods for transforming machine language models for a production environment are disclosed. In one embodiment, in an information processing device comprising at least one computer processor, a method for transforming machine language models for a production environment may include: (1) receiving, from a software development environment, a machine language model in a first language; (2) transforming the machine language model from the first language to a second language; (3) validating the transformed model in an operational environment; and (4) deploying the transformed model to a production environment.

In one embodiment, the software development environment may include a cloud-based software development environment.

In one embodiment, the machine learning model in the first language may be checked into a software repository.

In one embodiment, the machine learning model in the first language may be automatically transformed to a second language following check-in.

In one embodiment, validating the transformed model in an operational environment may include providing a first set of data to the transformed model; retrieving an output of the first set of data being provided to a prior model; and comparing an output of the transformed model to the output of the prior model. The transformed model is validated if the comparison of the output of the transformed model to the output of the prior model is within a predetermined amount.

In one embodiment, the first set of data may comprise test data, real-world data, etc.

In one embodiment, deploying the transformed model to a production environment may include defining at least one input for the transformed model.

In one embodiment, the production environment and the operational environment may be the same environment.

In one embodiment, the transformation may be performed by a Java engine.

According to another embodiment, a system for transforming machine language models for a production environment may include a software development environment hosted by at least one server; an operational environment hosted by at least one server; a production environment hosted by at least one server; and a transformation engine executed by an information processing device comprising at least one computer processor that performs the following: (1) receive, from the software development environment, a machine language model in a first language; and (2) transform the machine language model from the first language to a second language. The transformed model may be validated in the operational environment; and the transformed model may be deployed to a production environment.

In one embodiment, the software development environment may include a cloud-based software development environment.

In one embodiment, the software environment may include a software repository, and the machine learning model in the first language may be checked into the software repository.

In one embodiment, the machine learning model in the first language may be automatically transformed to a second language following check-in.

In one embodiment, validating the transformed model in an operational environment may include providing a first set of data to the transformed model; retrieving an output of the first set of data being provided to a prior model; and comparing an output of the transformed model to the output of the prior model. The transformed model is validated if the comparison of the output of the transformed model to the output of the prior model is within a predetermined amount.

In one embodiment, the first set of data may include test data, real-world data, etc.

In one embodiment, deploying the transformed model to a production environment may include defining at least one input for the transformed model.

In one embodiment, the production environment and the operational environment may be the same environment.

In one embodiment, the system may further include a Java engine that performs the transformation.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts an architectural diagram of a system for transforming machine language models for a production environment according to one embodiment;

FIG. 2 depicts a method for transforming machine language models for a production environment according to one embodiment;

FIG. 3 depicts a method for model deployment to a production environment according to one embodiment; and

FIG. 4 depicts a method for functional testing according to one embodiment.

### DETAILED DESCRIPTION OF PREFERRED EMBODIMENTS

Embodiments disclosed herein relate to transforming machine language models for a production environment. In one embodiment, a software-based scoring model may be developed using a machine learning algorithm (e.g., XGBoost) in Predictive Model Markup Language (PMML) that may include a plurality of decision trees. The scoring model may be used, for example, for scoring a transaction for potential fraud.

The model may then be transformed from a first language (e.g., an open-source language such as PMML) to a second language (e.g., a third generation computer language such as Cobol) for execution in a production environment. The score generated using this model may be used, for example, within an authorization decision engine to detect fraudulent transactions.

Embodiments may provide some or all of the following benefits: (1) a data scientist may create models in modern open source languages regardless of the production environment in which the model will execute; (2) models may be automatically transformed to software languages (e.g., third generation computer languages) as per the operational environment (e.g., a mainframe); and (3) machine learning models may be operationalized to run in core processing environments where the majority operational decisions are being made. Other benefits may be also be realized.

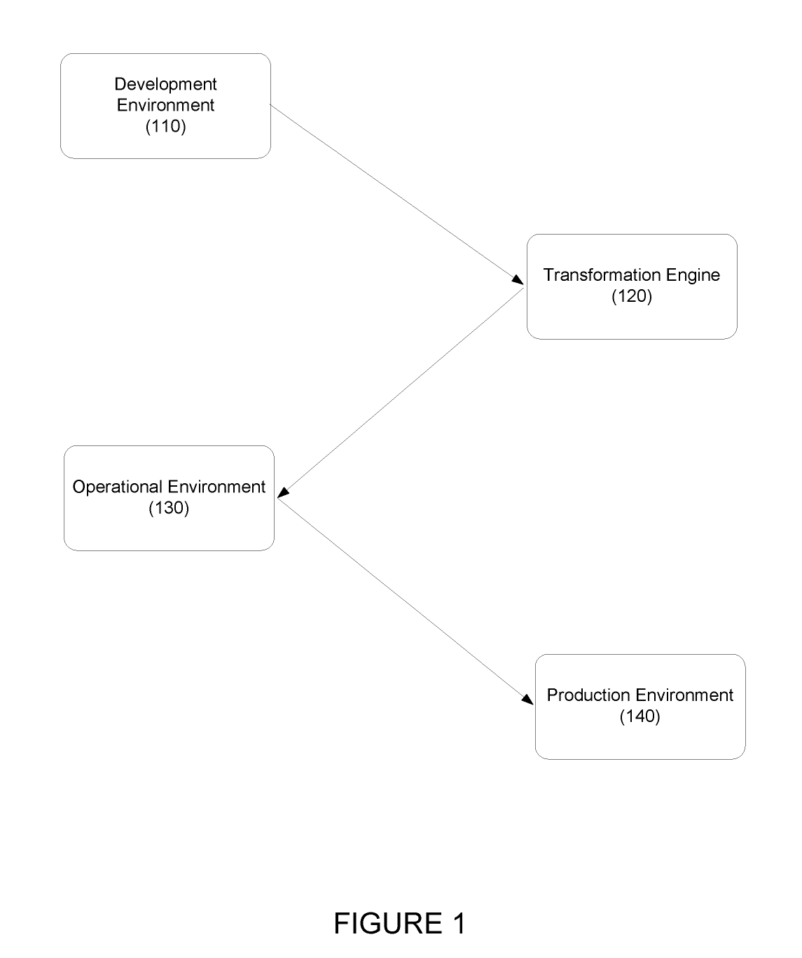

Referring to FIG. 1, a system for transforming machine language models for a production environment is disclosed according to one embodiment. System 100 may include a plurality of environments, such as development environment 110, operational environment 130, and production environment 140. In one embodiment, each environment may be hosted by a separate electronic device (e.g., server, workstation, etc.); in another embodiment, more than one environment may be hosted by the same electronic device(s). In addition, environments may differ based on inputs (e.g., operational environment 130 may receive test inputs, while production environment 140 may receive real-world inputs).

In one embodiment, development environment 110 may be a cloud-based development environment for developing the model. In one embodiment, a development team may develop the model in the development environment.

In one embodiment, operational environment may be an environment that simulates production environment 140 but is used for testing the model. In one embodiment, production environment 140 may be sandboxed from production environment 140.

In one embodiment, production environment 140 may be a live environment in which the model is employed.

In one embodiment, operational environment 130 and/or production environment 140 may be based on legacy systems, such as mainframe computers, that may not be able to execute the language in which the model is written. In one embodiment, system 100 may further include transformation engine 120 that may be used to transform a model written in a language, such as PMML, to a computer language that may be used in operational environment 130 and/or production environment 140.

In one embodiment, transformation engine 120 may be a java-based engine that transforms a model written in a first computer language (e.g., PMML) to a second computer language (e.g., a third generation computer language such as Cobol). In one embodiment, transformation engine 120 may be hosted by any of development environment 110, operational environment 130 and/or production environment 140.

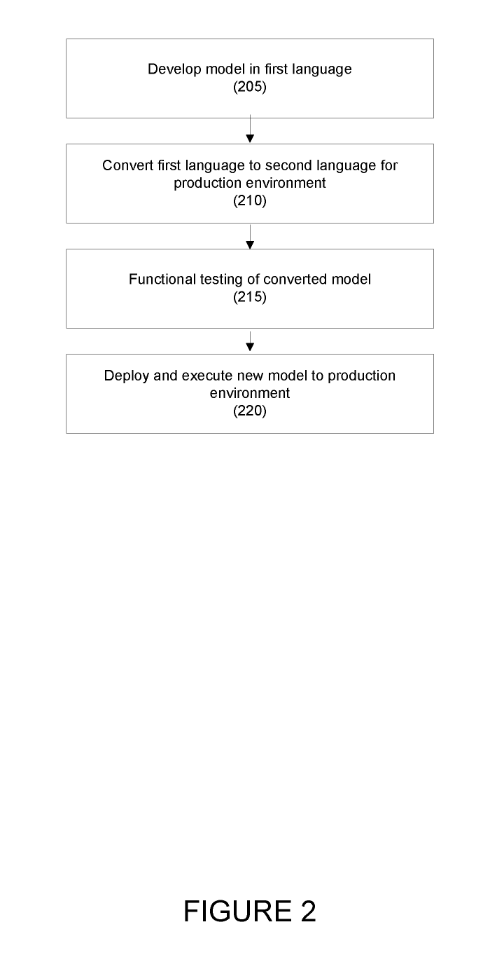

Referring to FIG. 2, a method for transforming machine language models for a production environment is disclosed according to one embodiment. In step 205, a machine learning model may be developed by, for example, a development team. In one embodiment, a machine learning model may be developed using a machine learning algorithm (e.g., XGBoost). In one embodiment, the machine learning model may be written in a language, such as R or any other suitable modeling language.

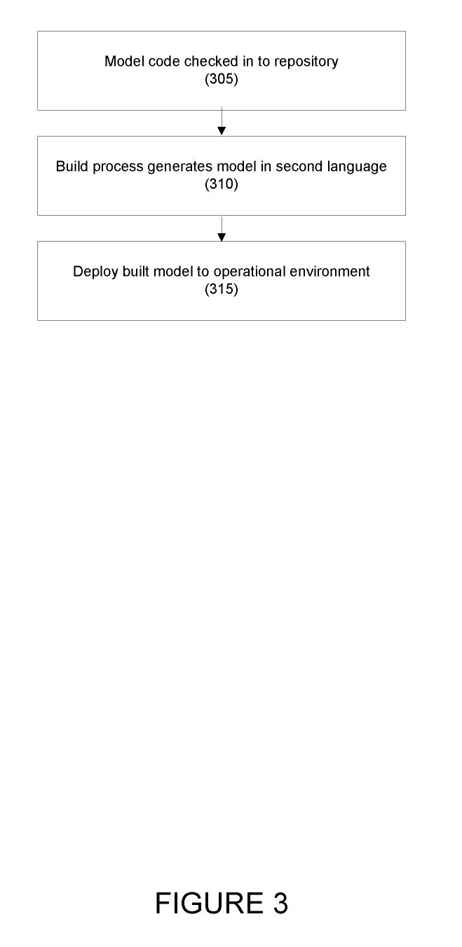

In step 210, the model may be converted one or more source files for a different language that may be used in an operational and/or production environment. In one embodiment, the input data interface may also be converted. For example, referring to FIG. 3, a method for online performance testing is provided according to one embodiment. In step 305, a user (e.g., a Risk Data Scientist team) may check-in code for the model to a software repository, such as Subversion, and in step 310, a build process (e.g., a Jenkins automated continuous build process) may be triggered to create code for the model in a different language that may be used by the operational and/or production environment.

In one embodiment, the build process may include converting the predictive machine learning models from the modeling language to PMML; creating a Java Class from the PMML Models using JPMML (Java PMML); and converting the Java Class is to a second program (e.g., in Cobol) using a Java program.

In one embodiment, in step 315, the model may then be deployed to the operational environment for testing. For example, the model may be deployed to a mainframe.

In one embodiment, an automated process may be used to transform the model once it is checked-in to the code repository to the second language, and/or to deploy the model to the operational and/or production environment.

In one embodiment, the interfacing API may be validated; any change to the API may require a new release.

After each promotion/deployment, an automated email may be sent to the development team to inform them of any updates, changes, etc.

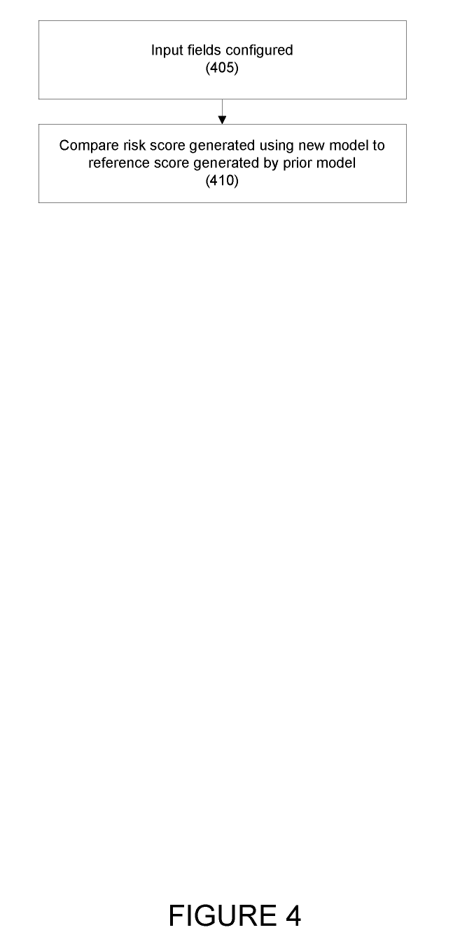

Referring again to FIG. 2, in step 215, the model may undergo functional testing in the operational environment. Referring to FIG. 4, a method for function testing is provided according to one embodiment. In one embodiment, the model may be tested in the operational environment. In another embodiment, the model may be tested in the production environment.

In step 405, the input fields for the model may be prepared, and test data may be provided. In one embodiment, the test data may be generated specifically for testing, or it may be actual data that has been processed by a prior model in the production environment.

In step 410, a score for the test data may be generated and compared to the score for the same data through the prior model. In one embodiment, the functional testing may run for a predetermined period of time (e.g., a week, a month, etc.), a predetermined number of transactions, or as necessary and/or desired.

In one embodiment, if the score for the new model is within a predetermined threshold of the score for the prior model, the model may be validated. In one embodiment, the score for the new model may be required to be the same as the prior model.

Referring again to FIG. 2, in step 220, the model may be executed in the production environment. In one embodiment, the inputs for the model may be changed, and the new model may be called.

In addition, the score may from the new model may be checked for validity, and the model may be revised as appropriate. In one embodiment, this may be done periodically, or as otherwise necessary and/or desired.

It should be recognized that although several embodiments have been disclosed, these embodiments are not exclusive and aspects of one embodiment may be applicable to other embodiments.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a cardholder or cardholders of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “cardholder interfaces” may be utilized to allow a cardholder to interface with the processing machine or machines that are used to implement the invention. As used herein, a cardholder interface includes any hardware, software, or combination of hardware and software used by the processing machine that allows a cardholder to interact with the processing machine. A cardholder interface may be in the form of a dialogue screen for example. A cardholder interface may also include any of a mouse, touch screen, keyboard, keypad, voice reader, voice recognizer, dialogue screen, menu box, list, checkbox, toggle switch, a pushbutton or any other device that allows a cardholder to receive information regarding the operation of the processing machine as it processes a set of instructions and/or provides the processing machine with information. Accordingly, the cardholder interface is any device that provides communication between a cardholder and a processing machine. The information provided by the cardholder to the processing machine through the cardholder interface may be in the form of a command, a selection of data, or some other input, for example.

As discussed above, a cardholder interface is utilized by the processing machine that performs a set of instructions such that the processing machine processes data for a cardholder. The cardholder interface is typically used by the processing machine for interacting with a cardholder either to convey information or receive information from the cardholder. However, it should be appreciated that in accordance with some embodiments of the system and method of the invention, it is not necessary that a human cardholder actually interact with a cardholder interface used by the processing machine of the invention. Rather, it is also contemplated that the cardholder interface of the invention might interact, i.e., convey and receive information, with another processing machine, rather than a human cardholder. Accordingly, the other processing machine might be characterized as a cardholder. Further, it is contemplated that a cardholder interface utilized in the system and method of the invention may interact partially with another processing machine or processing machines, while also interacting partially with a human cardholder.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for transforming machine language models for a production environment comprising:
in an information processing device comprising at least one computer processor:
receiving, from a software development environment, a machine language model in a first modeling language;
transforming the machine language model from the first modeling language to a second modeling language;
validating the transformed model in an operational environment; and
deploying the transformed model to a production environment.

2. The method of claim 1, wherein the software development environment comprises a cloud-based software development environment.

3. The method of claim 1, wherein the machine learning model in the first modeling language is checked into a software repository.

4. The method of claim 3, wherein the machine learning model in the first modeling language is automatically transformed to a second modeling language following check-in.

5. The method of claim 1, wherein validating the transformed model in an operational environment comprises:
providing a first set of data to the transformed model;
retrieving an output of the first set of data being provided to a prior model; and
comparing an output of the transformed model to the output of the prior model;
wherein the transformed model is validated if the comparison of the output of the transformed model to the output of the prior model is within a predetermined amount.

6. The method of claim 1, wherein the first set of data comprises test data.

7. The method of claim 1, wherein the first set of data comprises real-world data.

8. The method of claim 1, wherein deploying the transformed model to a production environment comprises defining at least one input for the transformed model.

9. The method of claim 1, wherein the production environment and the operational environment are the same environment.

10. The method of claim 1, wherein the transformation is performed by a Java engine.

11. A system for transforming machine language models for a production environment comprising:
a software development environment hosted by at least one server;
an operational environment hosted by at least one server;
a production environment hosted by at least one server; and
a transformation engine executed by an information processing device comprising at least one computer processor that performs the following
receive, from the software development environment, a machine language model in a first modeling language; and
transform the machine language model from the first modeling language to a second modeling language;
wherein the transformed model is validated in the operational environment; and
wherein the transformed model is deployed to a production environment.

12. The system of claim 11, wherein the software development environment comprises a cloud-based software development environment.

13. The system of claim 11, wherein the software environment comprises a software repository, and the machine learning model in the first modeling language is checked into the software repository.

14. The system of claim 13, wherein the machine learning model in the first modeling language is automatically transformed to a second modeling language following check-in.

15. The system of claim 11, wherein validating the transformed model in an operational environment comprises:
providing a first set of data to the transformed model;
retrieving an output of the first set of data being provided to a prior model; and
comparing an output of the transformed model to the output of the prior model;
wherein the transformed model is validated if the comparison of the output of the transformed model to the output of the prior model is within a predetermined amount.

16. The system of claim 11, wherein the first set of data is test data.

17. The system of claim 11, wherein the first set of data is real-world data.

18. The system of claim 11, wherein deploying the transformed model to a production environment comprises defining at least one input for the transformed model.

19. The system of claim 11, wherein the production environment and the operational environment are the same environment.

20. The system of claim 11, wherein the transformation is performed by a Java engine.
